(19) United States
(12) Patent Application Publication
(10) Pub. No.: US 2006/0282606 A1
(43) Pub. Date: Dec. 14, 2006

(54) System and method for automatically optimizing available virtual memory

(75) Inventors: Ramesh Radhakrishnan, Austin, TX (US); Ranjith Purushothaman, Austin, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/147,565

(22) Filed: Jun. 8, 2005

(51) Int. Cl. G06F 12/00

(52) U.S. Cl. 711/6; 711/202

(57) ABSTRACT

An information handling system includes a processor able to support a 64 bit operating system. The information handling system includes a memory resource in communication with the processor that is able to manage the memory resource as virtual memory for applications run by the processor. The information handling system includes a 32 bit application that can be run by the processor and a wrapper able to automatically determine whether the 32 bit application is Large Address Aware. If the wrapper determines that the 32 bit application is not Large Address Aware, the wrapper automatically modifies a Large Address Aware flag associated with the selected 32 bit application to allow the 32-bit application to take advantage of the additional virtual addressing capability of the 64 bit operating system.

### TECHNICAL FIELD

The present invention is related to the field of computer systems and more specifically to a system and method for automatically optimizing available virtual memory.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems include operating system that are able to run applications that were originally designed for use with a different operating system. For instance, some information handling systems utilize a 64 bit operating system that may also run existing applications designed for use with a 32 bit operating system. For instance, the 64 bit windows operating system accommodates loading, execution and management of 32 bit applications via a subsystem referred to as Windows-32-on-Windows-64 (WOW64).

One advantage of running a 32 bit application on a WOW64 sub system is that the WOW64 sub system can increase the available virtual memory accessible by some 32 bit applications. In particular, it is known that 32 bit applications that are “Large Address Aware” can take advantage of additional virtual addressing capabilities that are made available by 64 bit operating systems. In particular, 32 bit applications that are Large Address Aware and run by a 64 bit operating system may have full use of four (4) GB of virtual address space as opposed to the typical two (2) GB of virtual address space available to 32 bit applications.

However, in order for a 32 bit application to take advantage of the increased virtual addressing capability on 64 bit operating system platforms, the application must be coded with a Large Address Aware switch or the user must set a Large Address Aware flag for each particular 32 bit application using image header modification tools. As a result, increasing virtual address space requires a significant amount of administrator time, effort and expertise. As a result, very often 32 bit applications do not utilize the increased virtual address space that may be available for 32 bit applications running in a 64 bit operating system environment.

### SUMMARY OF THE INVENTION

Therefore a need has arisen for a system and method for automatically optimizing virtual memory available to 32 bit applications running in a 64 bit operating system environment.

In one aspect, an information handling system is disclosed including processor operable to support a 64 bit operating system. The information handling system also includes a memory resource in communication with the processor that is able to manage the memory resource as virtual memory for applications run by the processor. Information handling system also includes at least one 32 bit application that can be run by the processor and a wrapper able to automatically determine whether a selected 32 bit application is Large Address Aware. If the wrapper determines that the 32 bit application is not Large Address Aware, the wrapper modifies a Large Address Aware flag associated with the selected 32 bit application.

In another aspect, a method is disclosed that include providing a wrapper for use with an information handling system that is able to run a 64 bit operating system and having at least one 32 bit application that may be run by the 64 bit operating system. The method also includes automatically determining, with the wrapper, whether a selected 32 bit application is Large Address Aware. Additionally, in response to determining that the selected 32 bit application is not Large Address Aware, the method includes modifying a Large Address Aware flag associated with the selected 32 bit application.

In yet another aspect, a wrapper application for optimizing virtual memory available to a 32 bit application on an information handling system that has a 64 bit operating system is disclosed. The wrapper may automatically determined whether a selected 32 bit application is Large Address Aware and, in response to determining that the selected 32 bit application is not Large Address Aware, modify a Large Address Aware flag associated with the 32 bit application.

The present disclosure includes a number of important technical advantages. One technical advantage is providing a wrapper in a information handling system using a 64 bit operating system to determine whether or not a 32 bit application is Large Address Aware. This determination allows each 32 bit application run on a information handling system using a 64 bit operating system to be coded or flagged as Large Address Aware and provide full use of available virtual address space. Additional advantages will be apparent to those of skill in the art from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows an information handling system according to teachings of the present disclosure;

FIG. 2 shows a processor and virtual memory according to an embodiment of the present disclosure;

FIG. 3 shows another embodiment of a processor of an information handling system and memory according to an embodiment of the present disclosure;

FIG. 4 shows a flow diagram of a method according to teachings of the present disclosure;

FIG. 5 shows a In-Memory image according to teachings of the present disclosure; and

FIG. 6 shows a Portable Executable (PE) image according to teachings of the present disclosure.

### DETAILED DESCRIPTION OF THE INVENTION

Preferred embodiments of the invention and its advantages are best understood by reference to FIGS. 1-6 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system according to present disclosure, indicated generally at 100, is shown. Information handling system 100 includes processor 110, chip set 112, a basic input/output system (BIOS) 114, memory 116 and hard drive 120. Chip set 112 is coupled to processor 110, hard drive 120, BIOS 114 and memory 116.

System 100 may operate by executing BIOS 114 for a system firmware (not expressly shown) in response to being powered up or reset. BIOS 114 identifies and initializes the components of system 100 and causes an operating system 122 to be booted. Operating system 122 may allow the user of system 100 to initiate and run one or more applications 124 on system 100. Applications 124 may be stored on hard drive 120 or may be stored on a remote storage resource communicatively coupled with system 100. System 100 may be networked with additional information handling system or components.

In the present embodiment hard drive 120 includes operating system 122, applications 124 and wrapper 126. Operating system 122 is preferable a 64 bit operating system that may also run one or more 32-bit applications. The 64 bit operating system 122 may be, for example, an Extended Memory 64 Technology (EM64T). In the particular embodiment, operating system 122 comprises a Windows-32-on-Windows-64 (WOW64) subsystem for executing 32 bit applications. Wrapper 26 may preferably include a set of executable instructions which may be executed by processor 110 to determine the Large Address Aware characteristics of one or more applications 124. In a preferred embodiment, wrapper 126 may be integrated into the factory image of system 100. Wrapper 126 may be applied to multiple applications 124. In an alternate embodiment, multiple wrappers 126 may be provide such that on or more wrappers may be dedicated to one or more particular applications.

Applications 124 includes at least one 32 bit application which may be run by operating system 122. In some embodiments, applications 124 may include a plurality of 32 bit applications which may be run by operating system 122. Applications 124 may also include 64 bit applications which may be run by operating system 122. A 32 bit windows application by itself will typically not be aware of the presence of WOW64 and does not know if it is running on a 32 bit OS, or in compatibility mode on a 64 bit OS utilizing a WOW64 or other similar environment.

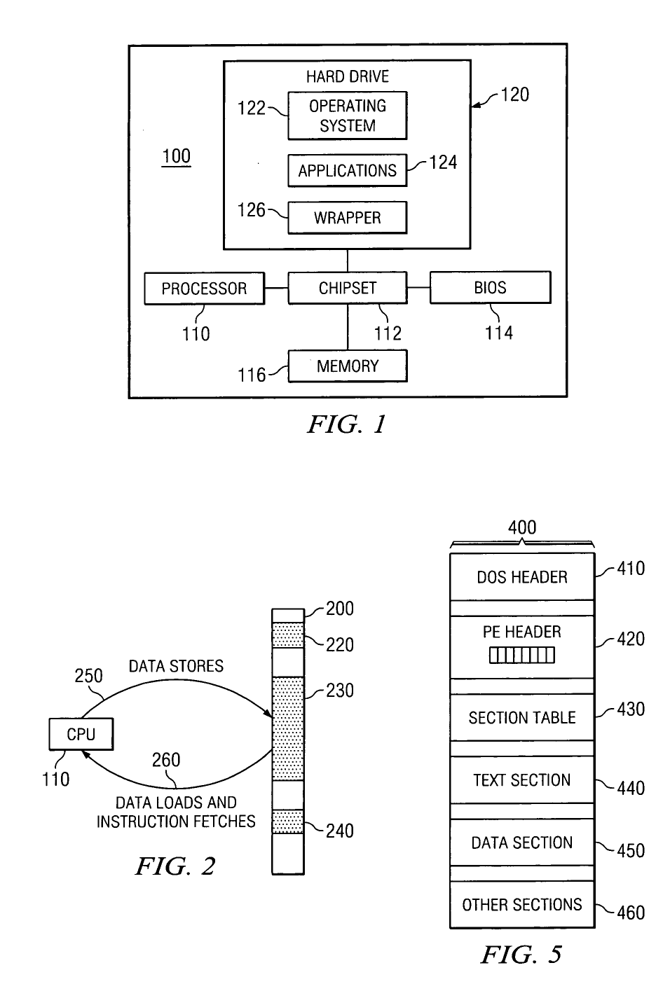

Now referring to FIG. 2, a diagram showing CPU 110 in communication with virtual memory 200 is shown. Virtual memory 200 is a portion of memory 116. In the present embodiment, memory 116 is a portion of hard drive 120. Virtual memory 200 includes pages 220, 230 and 240 stored thereon. Virtual memory 200 may receive data stores 250 from CPU 110 and may also send data loads and instruction fetches 260 to CPU 110. In some embodiments, virtual memory 200 is managed by operating system 122.

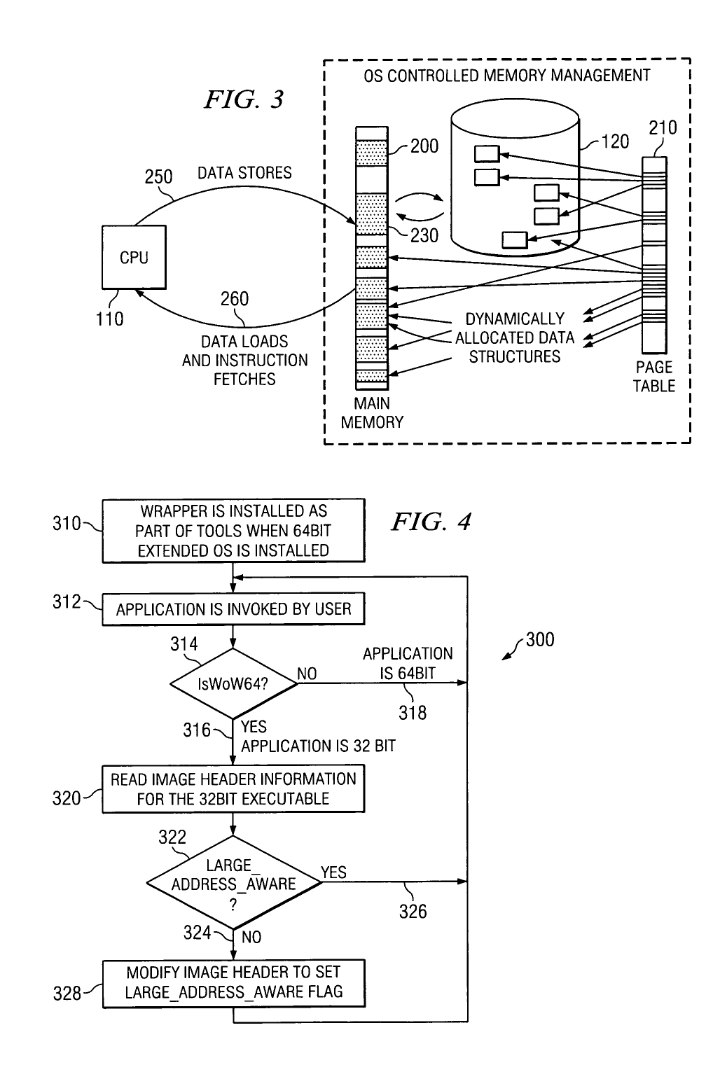

Now referring to FIG. 3, a figure showing CPU sending data stores 250 and receiving data loads and instructions fetches 260 from virtual memory 200 is shown. Virtual memory 200 is in communication with page table 210, which in turn is in communication with storage resource 120. In the present embodiment, storage resource 120 may be a hard drive. Page table 210 is operable to send pages from hard drive 120, store them within page table 210 and transfer them to virtual memory 200. Programs stored on hard drive 120 are typically split into fixed size pages. These pages represent the virtual memory for that program. Only a pages that are needed are stored in physical memory. Page table 210 (which may be formed in memory, cache or a disk depending on implementation) preferably stores the list of pages that are in physical memory and the mapping from virtual to physical pages.

Now referring to FIG. 4, a flow chart showing a method 300 according to teachings of the present disclosure is shown. Preferably, method 300 takes place automatically without any involvement by a user or system administrator and wrapper 126 performs the Large Address Aware analysis during the initial use of a 32 bit application on the system 100. Method 300 begins as wrapper 126 is installed 310. In the present embodiment, wrapper 126 is installed as part of the tools provided for use with the 64 bit operating system. Next an application 124 is invoked by user 312. The wrapper first determines whether the operating system is a 64 bit operating system that may also run 32 bit applications. In the present embodiment, in step 314 the wrapper determines whether the operating system 122 of system 100 incorporates a WOW64 subsystem. If the application does not include a WOW64 operating system, the method then returns to step 312 and awaits for the next application to be invoked.

If the operating system is a WOW64 system 316, then the image header information for the 32 bit executable application is read 320. Next, the method determines whether the selected application is Large Address Aware 322. If the application is Large Address Aware 326 then the method returns to step 312. However, if the selected 32 bit application is not Large Address Aware 324, the method proceeds to modifying the image header to set a Large Address Aware flag 328. The method then returns to step 312 and awaits the selection of an application by a user.

In the present preferred embodiment wrapper 126 queries will check image file Large Address Aware 554 to determine whether a Large Address Aware flag has been set for a selected application.

Now referring to FIG. 5, an In-Memory image is shown and referred to generally at 400. In-Memory image 400 is typically located On hard drive 120 and may be in Portable Executable or Common Object File Format (COFF). In-Memory image 400 generally includes DOS header 410, portable executable header 420, section table 430, dot text section 440, dot data section 450 and other sections 460. In the present embodiment, wrapper 126 preferably determines whether a particular 32 bit application is set to be Large Address Aware by querying bit six (6) of PE header 420.

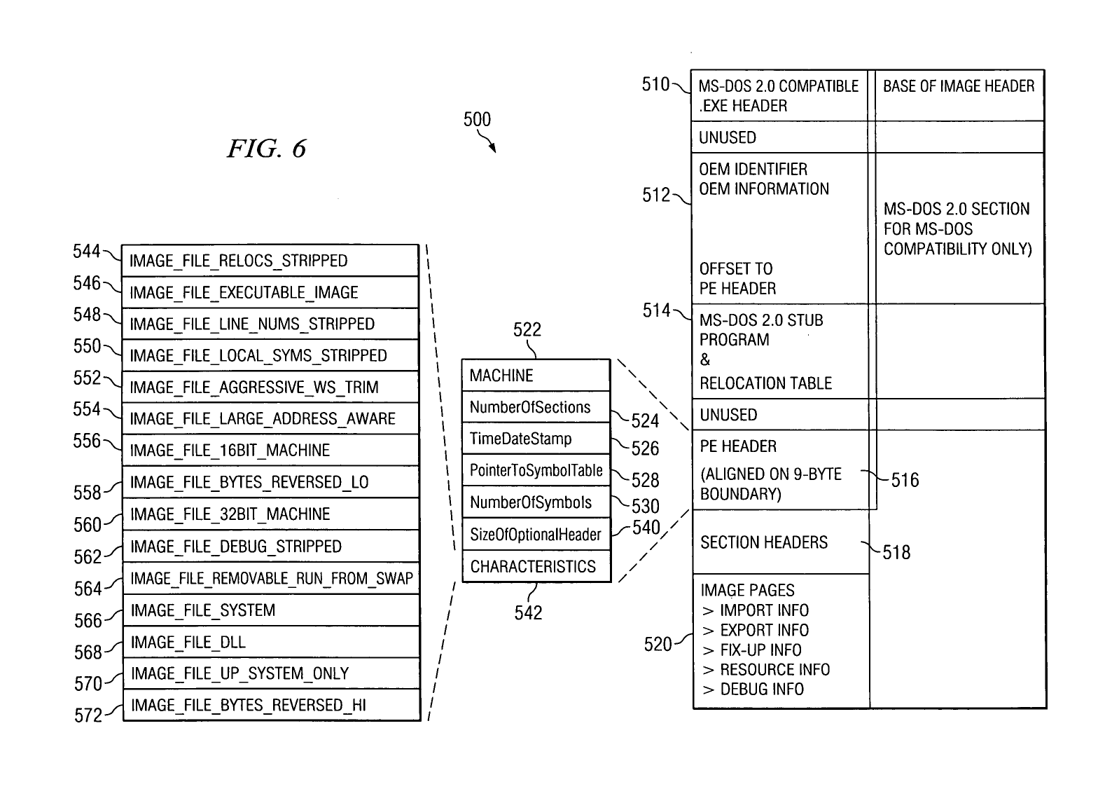

Now referring to FIG. 6, a standard portable executable image is shown generally at 500. Portable executable image includes MS-DOS 2.0 compatible .EXE header 512, OEM identifier/OEM information/Offset to PE header section 514, MS-DOS 2.0 stub program & relocation table 514, PE header 516 (which may correspond to PE header 420 shown in FIG. 5), section headers 518 and image pages 520. Image pages 520 include import information, export information, fix-up information, resource information and debug information.

PE header is shown in an expanded form and includes machine 522, number of sections 524, time date stamp 526, pointer to symbol table 528, number of symbols 530, size of optional header 540 and characteristics 542 Additionally, characteristics section 542 is expanded to include the following image files:

| | |
|---|---|
| IMAGE_FILE_RELOCS_STRIPPED | 544 |
| IMAGE_FILE_EXECUTABLE_IMAGE | 546 |
| IMAGE_FILE_LINE_NUMS_STRIPPED | 548 |
| IMAGE_FILE_LOCAL_SYMS_STRIPPED | 550 |
| IMAGE_FILE_AGGRESSIVE_WS_TRIM | 552 |
| IMAGE_FILE_LARGE_ADDRESS_AWARE | 554 |
| IMAGE_FILE_16BIT_MACHINE | 556 |
| IMAGE_FILE_BYTES_REVERSED_LO | 558 |
| IMAGE_FILE_32BIT_MACHINE | 560 |
| IMAGE_FILE_DEBUG_STRIPPED | 562 |
| IMAGE_FILE_REMOVABLE_RUN_FROM_SWAP | 564 |
| IMAGE_FILE_SYSTEM | 566 |
| IMAGE_FILE_DLL | 568 |
| IMAGE_FILE_UR_SYSTEM_ONLY | 570 |
| IMAGE_FILE_BYTES_REVERSED_HI | 572 |

IMAGE_FILE_LARGE_ADDRESS_AWARE 554 field (which may also be referred to as the Large Address Aware flag) corresponds to bit 6 of the characteristics section 542 under PE Header 516. As discussed above, wrapper 126 may preferably modify Large Address Aware flag 554 of a 32 bit application in response to determining that a 32 bit application is not large address aware. Such modification of the large address aware flag 554 improves performance of the 32-bit application by taking advantage of the additional virtual addressing capability.

Although the disclosed embodiments have been described in detail, it should be understood that various changes, substitutions and alterations can be made to the embodiments without departing from their spirit and scope.

What is claimed is:

1. An information handling system comprising:
a processor operable to support a 64 bit operating system;
a memory resource in communication with the processor, the processor operable to manage the memory resource as virtual memory for applications run by the processor;
at least one 32 bit application operable to be run by the processor; and
a wrapper operable to automatically determine whether a selected 32 bit application is large address aware and to modify a large address aware flag associated with the selected 32 bit application in response to determining that the selected 32 bit application is not large address aware.

2. An information handling system according to claim 1 wherein the 64 bit operating system comprises a Windows-32-on-Windows-64 (WOW64) subsystem operable to run 32-bit applications.

3. An information handling system according to claim 1, the wrapper further operable to determine the large address aware status of the at least one 32 bit application during an initial use thereof.

4. An information handling system according to claim 1 further comprising a plurality of 32 bit applications.

5. An information handling system according to claim 4 wherein the wrapper is further operable to:
determine whether each 32 bit application is large address aware; and
in response to determining that at least one 32 bit application is not large address aware, modify a large address aware flag associated with the at least one 32 bit application.

6. An information handling system according to claim 1 wherein the at least one 32 bit application is stored in a storage resource in communication with the processor.

7. An information handling system according to claim 6 wherein the storage resource comprises a hard drive.

8. An information handling system according to claim 6 further comprising a page table within the memory operable to store pages retrieved from the storage resource.

9. An information handling system according to claim 6 where the wrapper is stored within the storage resource.

10. An information handling system according to claim 1 wherein the wrapper is operable to query bit six of a PE header associated with the selected 32 bit application to determine the large address aware status of the 32 bit application.

11. A method comprising:
providing a wrapper for use within an information handling system operable to run a 64-bit operating system and having at least one 32 bit application operable to be run by the 64 bit operating system;
automatically determining, with the wrapper, whether a selected 32 bit application is large address aware; and
in response to determining that the selected 32 bit application is not large address aware, modifying a large address aware flag associated with the selected 32 bit application.

12. A method according to claim 11 further comprising providing the wrapper for use with an information handling system operable to run a Windows-32-on-Windows-64 subsystem associated with the 64 bit operating system.

13. A method according to claim 11 further comprising determining the large address aware status of the selected 32 bit application during an initial use thereof.

14. A method according to claim 11 further comprising:
automatically determining, with the wrapper, whether any of a plurality of 32 bit application is large address aware; and
in response to determining that at least one 32 bit application is not large address aware, modifying a large address aware flag associated with each at least one 32 bit application.

15. A method according to claim 11 further comprising:
storing the at least one 32 bit application on a storage resource associated with the information handling system; and
storing the wrapper on the storage resource.

16. A method according to claim 11 wherein determining the at least one 32 bit application is not large address aware further comprises querying bit six of a PE header associated with the selected 32 bit application.

17. A wrapper application for optimizing virtual memory available to a 32 bit application on an information handling system having a 64 bit operating system comprising, the wrapper operable to:
automatically determine whether a selected 32 bit application is large address aware; and
in response to determining that the selected 32 bit application is not large address aware, modify a large address aware flag associated with the selected 32 bit application.

18. A wrapper according to claim 17 wherein deterring whether a selected 32 bit application is large address aware comprises querying bit six of a PE header associated with the selected 32 bit application.

19. A wrapper according to claim 17 further operable to determine the large address aware status of the at least one 32 bit application during an initial use thereof.

20. A wrapper according to claim 17 further operable to determine the large address aware status of a plurality of 32 applications associated with a selected information handling system.
